(19) United States
(12) Patent Application Publication
(10) Pub. No.: US 2018/0082184 A1
(43) Pub. Date: Mar. 22, 2018

(54) CONTEXT-AWARE CHATBOT SYSTEM AND METHOD

(71) Applicant: TCL RESEARCH AMERICA INC., San Jose, CA (US)

(72) Inventors: LIFAN GUO, San Jose, CA (US); HAOHONG WANG, San Jose, CA (US)

(73) Assignee: TCL RESEARCH AMERICA INC.

(21) Appl. No.: 15/269,551

(22) Filed: Sep. 19, 2016

(51) Int. Cl. G06N 5/02; G10L 15/26; G06F 17/27; G10L 15/22

(52) U.S. Cl. CPC G06N 5/02; G10L 15/26; G06F 17/277; G10L 15/22; G06F 17/279

(57) ABSTRACT

A context-aware chatbot method and system are provided. The context-aware chatbot method comprises receiving a user's voice; converting the user's voice to a question to be answered; determining a question type of the question to be answered; generating at least one answer to the question based on a context-aware neural conversation model; validating the answer generated by the context-aware neural conversation model; and delivering the answer validated to the user. The context-aware neural conversation model takes contextual information of the question into consideration, and decomposes the contextual information of the question into a plurality of high dimension vectors.

### FIELD OF THE INVENTION

The present invention relates generally to the field of computer technologies and, more particularly, to a context-aware chatbot system and method.

### BACKGROUND

As E-commerce is emerging, successful information access on E-commerce websites, which accommodate both customer needs and business requirements, becomes essential and critical. Menu driven navigation and keyword search provided by most commercial sites have tremendous limitations, as they tend to overwhelm and frustrate users with lengthy and rigid interactions. User interest in a particular site often decreases exponentially with the increase in the number of mouse clicks. Thus, shortening the interaction path to provide useful information becomes important.

Many E-commerce sites attempt to solve the problem by providing keyword search capabilities. However, keyword search engines usually require users to know domain-specific jargon. Unfortunately, keywords search does not allow users to precisely describe the user intention, and more importantly, keyword search lacks an understanding of the semantic meanings of the search words and phrases. For example, keyword search engines usually may not understand that “summer dress” should be looked up in women's clothing under “dress”, whereas “dress shirt” most likely in men's under “shirt”. A search for “shirt” often reveals dozens or even hundreds of items, which are useless for somebody who has a specific style and pattern in mind.

Given the abovementioned limitations, a current solution is natural language (and multimodal) dialog, namely chatbot. Chatbot has been used in a large variety of fields, such as call-center/routing applications, e-mail routing, information retrieval and database access, and telephony banking, etc. Recently, chatbot has become even more popular with the access to a large number of user data.

However, according to the present disclosure, existing chatbot technologies are often restricted to specific domains or applications (e.g., booking an airline ticket) and require handcrafted rules. Furthermore, in a real dialogue between a user and a robot, user's context could be substantially complex and continuously changed. Thus, context-aware and proactive technologies are highly desired to be incorporated into a chatbot system.

The disclosed methods and systems are directed to solve one or more problems set forth above and other problems.

### BRIEF SUMMARY OF THE DISCLOSURE

One aspect of the present disclosure includes a context-aware chatbot method. The context-aware chatbot method comprises receiving a user's voice; converting the user's voice to a question to be answered; determining a question type of the question to be answered; generating at least one answer to the question based on a context-aware neural conversation model; validating the answer generated by the context-aware neural conversation model; and delivering the answer validated to the user. The context-aware neural conversation model takes contextual information of the question into consideration, and decomposes the contextual information of the question into a plurality of high dimension vectors.

One aspect of the present disclosure includes a non-transitory computer-readable medium having computer program for, when being executed by a processor, performing a context-aware chatbot method based on multimodal deep neural network. The method comprises. The context-aware chatbot method comprises receiving a user's voice; converting the user's voice to a question to be answered; determining a question type of the question to be answered; generating at least one answer to the question based on a context-aware neural conversation model; validating the answer generated by the context-aware neural conversation model; and delivering the answer validated to the user. The context-aware neural conversation model takes contextual information of the question into consideration, and decomposes the contextual information of the question into a plurality of high dimension vectors.

One aspect of the present disclosure includes a context-aware chatbot system. The context-aware chatbot system comprises a question acquisition module configured to receive a user's voice and convert the user's voice to a question to be answered; a question determination module configured to determine a question type of the question to be answered; a context-aware neural conversation module configured to generate at least one answer to the question by taking contextual information of the question into consideration and decomposing the contextual information of the question into a plurality of high dimension vectors; an evidence validation module configured to validate the answer generated by the context-aware neural conversation model; and an answer delivery module configured to deliver the answer validated to the user.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary environment incorporating certain embodiments of the present invention;

FIG. 2 illustrates an exemplary computing system consistent with disclosed embodiments;

FIG. 3 illustrates an exemplary context-aware chatbot system consistent with disclosed embodiments;

FIG. 4 illustrates a flow chart of an exemplary context-aware chatbot method consistent with disclosed embodiments; and

FIG. 5 illustrates an examplary context-aware neural conversational model consistent with disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

Chatbot systems are paramount for a wide range of tasks in enterprise. A chatbot system has to communicate clearly with its suppliers and partners, and engage clients in an ongoing dialog, not merely metaphorically but also literally, which is essential for maintaining an ongoing relationship. Communication characterized by information-seeking and task-oriented dialogs is central to five major families of business applications: customer service, help desk, website navigation, guided selling, and technical support.

Customer service responds to customers' general questions about products and services, e.g., answering questions about applying for an automobile loan or home mortgage. Help desk responds to internal employee questions, e.g., responding to HR questions. Website navigation guides customers to relevant portions of complex websites. A “Website concierge” is invaluable in helping people determine where information or services reside on a company's website. Guided selling provides answers and guidance in the sales process, particularly for complex products being sold to novice customers. Technical support responds to technical problems, such as diagnosing a problem with a device.

In commerce, clear communication is critical for acquiring, serving, and retaining customers. Companies often educate their potential customers about their products and services and, meanwhile, increase customer satisfaction and customer retention by developing a clear understanding of their customers' needs. However, customers are often frustrated by fruitless searches through websites, long waiting in call queues to speak with customer service representatives, and delays of several days for email responses. Thus, correct and prompt answers to customers' inquiries are highly desired.

The existing chatbot systems focus on training the question-answer pairs and recommending the most likely response to individual users, while not taking any contextual information into consideration. Contextual information refers to information relevant to an understanding of the text, for example, the identity of things named in the text: people, places, books, etc., information about things named in the text: birth dates, geographical locations, date published, etc., interpretive information: themes, keywords, and normalization of measurements, dates, etc.

That is, traditionally chatbot systems only deal with users and conversations, but do not embed the conversation into a context when responding to the users. Considering only users and conversations may be insufficient for many applications. For example, using the temporal context, a travel conversational system would provide a vacation recommendation in the winter which may be very different from the one in the summer. Similarly, in a consumer conversational system, it is important to determine what content and when to be delivered to a customer. Thus, incorporating the contextual information in the conversational system to response to users in certain circumstances are highly desired.

Mapping sequences to sequences based on neural networks has been used for neural machine translation, improving English-French and English-German translation task. Because vanilla recurrent neural networks (RNNs) suffer from vanishing gradients, variants of the Long Short Term Memory (LSTM) recurrent neural network may be adopted. Besides, bots and conversational agents have been proposed. However, most of these systems require a rather complicated processing pipeline of many stages, and the corresponding methods do not consider the changes in the user's context.

The present disclosure provides a context-aware chatbot method based on a neural conversational model, which may take contextual features into consideration. The neural conversational model may be trained end-to-end and, thus, may require significantly fewer handcrafted rules. The disclosed context-aware chatbot method may incorporate contextual information in a neural conversational model, which may enable a chatbot to be aware of context in a communication with the user. A contextual real-valued input vector may be provided in association with each word to simplify the training process. The vector learned from the context may be used to convey the contextual information of the sentences being modeled.

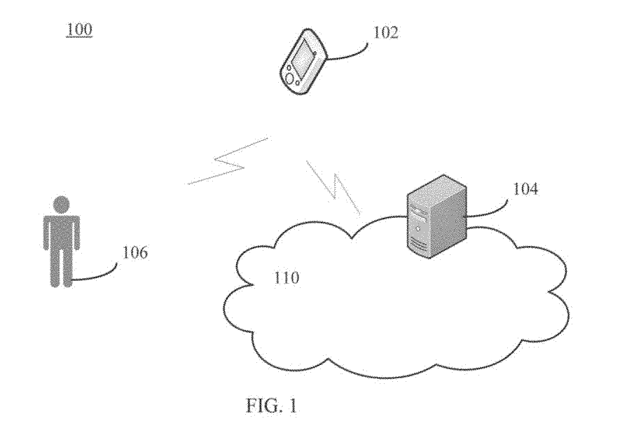

FIG. 1 illustrates an exemplary environment 100 incorporating certain embodiments of the present invention. As shown in FIG. 1, the environment 100 may include a user terminal 102, a server 104, a user 106, and a network 110. Other devices may also be included.

The user terminal 102 may include any appropriate type of electronic device with computing capabilities, such as a wearable device (e.g., a smart watch, a wristband), a mobile phone, a smartphone, a tablet, a personal computer (PC), a server computer, a laptop computer, and a digital personal assistant (PDA), etc.

The server 104 may include any appropriate type of server computer or a plurality of server computers for providing personalized contents to the user 106. For example, the server 104 may be a cloud computing server. The server 104 may also facilitate the communication, data storage, and data processing between the other servers and the user terminal 102. The user terminal 102, and server 104 may communicate with each other through one or more communication networks 110, such as cable network, phone network, and/or satellite network, etc.

The user 106 may interact with the user terminal 102 to query and to retrieve various contents and perform other activities of interest, or the user may use voice, hand or body gestures to control the user terminal 102 if speech recognition engines, motion sensor or depth-camera is used by the user terminal 102. The user 106 may be a single user or a plurality of users, such as family members.

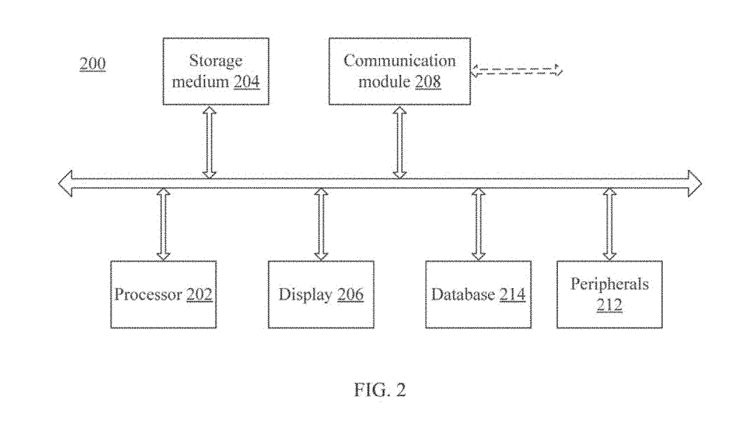

The user terminal 102, and/or server 104 may be implemented on any appropriate computing circuitry platform. FIG. 2 shows a block diagram of an exemplary computing system capable of implementing the user terminal 102, and/or server 104.

As shown in FIG. 2, the computing system 200 may include a processor 202, a storage medium 204, a display 206, a communication module 208, a database 214, and peripherals 212. Certain components may be omitted and other components may be included.

The processor 202 may include any appropriate processor or processors. Further, the processor 202 can include multiple cores for multi-thread or parallel processing. The storage medium 204 may include memory modules, such as ROM, RAM, flash memory modules, and mass storages, such as CD-ROM and hard disk, etc. The storage medium 204 may store computer programs for implementing various processes, when the computer programs are executed by the processor 202.

Further, the peripherals 212 may include various sensors and other I/O devices, such as keyboard and mouse, and the communication module 208 may include certain network interface devices for establishing connections through communication networks. The database 214 may include one or more databases for storing certain data and for performing certain operations on the stored data, such as database searching.

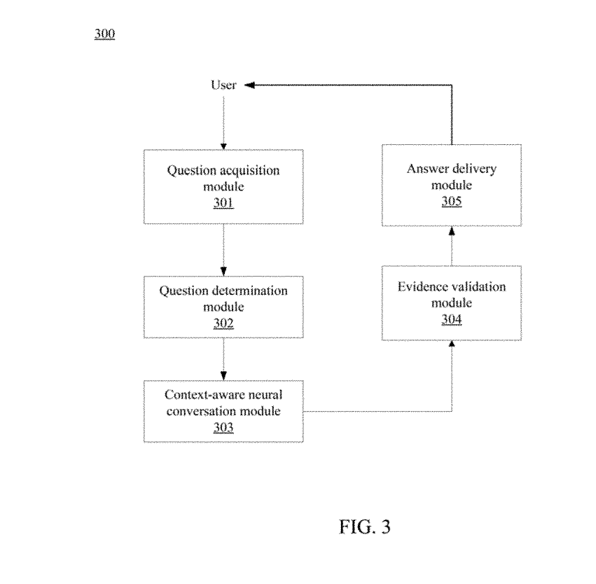

Returning to FIG. 1, the user terminal 102 and the server 104 may be implemented with a context-aware chatbot system. FIG. 3 illustrates an exemplary context-aware chatbot system. As shown in FIG. 3, the context-aware chatbot system 300 may include a question acquisition module 301, a question determination module 302, a context-aware neural conversation module 303, an evidence validation module 304, and an answer delivery module 305.

The question acquisition module 301 may be configured to receive a user's question. The user's questions may be received in various ways, for example, text, voice, sign language. In one embodiment, the question acquisition module 301 may be configured to receive a user's voice and convert the user voice to a corresponding question, for example, with the help of speech recognition engines.

The question determination module 302 may be configured to analyze the question and determine a question type. Analyzing the question may refer to deriving the semantic meaning of that question (what the question is actually asking). The question determination module 302 may be configured to analyze the question through deriving how many parts or meanings are embedded in the question. Features of questions may be learned for a question-answer matching.

In particular, the question determination module 302 may be configured to identify Lexical Answer Type (LAT). A lexical answer type is a word or noun phrase in the question that specifies the type of the answer without any attempt to understand its semantics. Determining whether or not a candidate answer can be considered an instance of the LAT is an important kind of scoring and a common source of critical errors. For example, given a question “recommend me some restaurant?”, the question analysis module 302 may be configured to analyze the syntax of the sentence and infer that the question is asking for a place.

The context-aware neural conversation module 303 may be configured to generate answers to the question and a sequence of answers to the question based on a context-aware neural conversation model, i.e., use the data from the question analysis to generate candidate answers. In particular, when a question is received, the context-aware neural conversation module 303 may be confiugred to recognize the contextual information of the question even the context is not appeared. For example, the context-aware neural conversation module 303 may be configured to add time, and event, etc., as input into the context-aware neural conversational model.

Moreover, the context-aware neural conversation module 303 may be configured to infer answers to questions even if the evidence is not readily present in the training set, which may be important because the training data may not contain explicit information about every attribute of each user. The context-aware neural conversation module 303 may be configured to learn event representations based on conversational content produced by different events, in which events producing similar responses may tend to have similar embeddings. Thus, the training data nearby in the vector space may increase the generalization capability of the context-aware neural conversation model.

The evidence validation module 304 may be configured to validate the answer generated by the context-aware neural conversation module 303. Although the answers are generated, the user may not accept the answer. Thus, evidence validation module 304 may be configured to calculate a confidence score for quality control. In one embodiment, the confidence score may be calculated in Kullback-Leibler distance between the question and the answer, and then normalized between 0 and 1.

For example, a predetermined confidence score may be provided as a standard, if the calculated confidence score is larger than the predetermined confidence score, the corresponding answer may be considered as valid. The answer delivery module 305 may be configured to deliver the validated answer to the user. If the calculated confidence score is smaller than the predetermined confidence score, the corresponding answer may be considered as invalid. Then the context-aware neural conversation module 303 may generate a new answer until the answer is validated. In addition, the validated answers may also be used for training for the future questions.

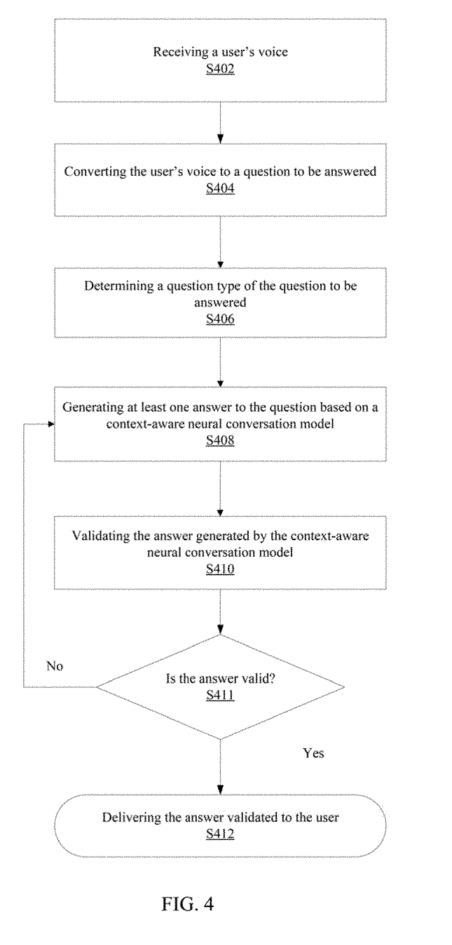

The present disclosure also provides a context-aware chatbot method. To take the contextual inforamiton into consideration, the context-aware chatbot method may model the response with context. Each event may be represented as a vector for embedding, such that event information (e.g., weather, traffic) that influences the content and style of responses may be encoded. FIG. 4 illustrates a flow chart of an exemplary context-aware chatbot method consistent with disclosed embodiments.

As shown in FIG. 4, at the beginning, user's voice is received (S402). The user's voice may be in real time or may be recorded, and the user's voice may be received by a microphone and then converted into a digital format or into a data file. The user's voice may also be received in data of digital format or in the form of data file. Any appropriate method may be used to receive the user data.

Further, and the user's voice is converted to a question to be answered (S404). That is, a question is issued by the user in his/her voice. In one embodiment, the user's voice may be recognized into text and the question may be obtained by analyzing the text. Or the data of the user's voice may be analyzed to obtain the question or questions. In another embodiment, the question to be answered may be received in other ways, for example, text, sign language, not only limited to voice.

Then, the question to be answered is analyzed to determine a question type (S406). For example, the question to be answered may be regarding time, location or place, etc. The question to be answered may be analyzed through deriving how many parts or meanings are embedded in the question to be answered. In one embodiment, the question type may be determined through identifying Lexical Answer Type (LAT). For example, given a question “recommend me some restaurant?”, the syntax of the sentence may be analyzed, and the question to be answered may be inferred as a question regarding a place.

After the question type is determined, at least one answer to the question are generated based on a context-aware neural conversation model (S408). That is, candidate answers may be generated based on the data from the step S406. A sequence of answers to the question to be answered may also be generated based on the context-aware neural conversation model, in which the answers may be ranked in a certain order, for example, an order of preference.

In particular, when a question is received by the context-aware neural conversation model, the context-aware neural conversation model may recognize the contextual information even the context is not appeared. For example, the context-aware neural conversation model may add time, and event, etc., as input into the context-aware neural conversational model.

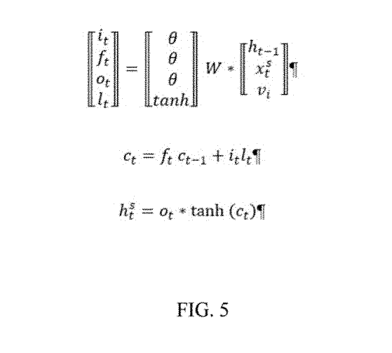

FIG. 5 illustrates an examplary context-aware neural conversational model consistent with disclosed embodiments. As shown in FIG. 5, each toekn in a sentence may be associated with a event-level representation vᵢ∈R^{k*1} . In standard SEQ2SEQ model, a sentence S may be encoded into a vector representation h_{S} using the source LSTM. Then for each stemp in the target side, hidden units may be obtained by combining the representation producted by the target LSTM at the previous time step, the word representations at the current time step, and the context embedding vᵢ.

The context-aware neural conversation model may add a hidden layer that encodes the event information vᵢ, making the response context awareable. The embedding vᵢ may be shared across all conversations that involve event i. {vᵢ} may be learned by back propagating word prediction errors to each neural component during training.

Moreover, the context-aware neural conversation model may be able to infer answers to questions even if the evidence is not readily present in the training set, which may be important as the training data may not contain explicit information about every attribute of each user. The context-aware neural conversation model may learn event representatios based on conversational content produced by different events, and events producing similar respnses may tend to have similar embeddings. Thus, the training data nearby in the vector space may increase the generalization capability of the model.

For example, considering a question-answer pair “recommend some place for fun” and “I think lake tahoe is good” which is generated in winter season, the context-aware neural conversation model may add time, location, people and other contextual information as inputs in the training process, which may be embedded into the learning of restaruant representations considering the contextual information. Then, the “lake tahoe” may be a better answer for the winter season. In the test process, when a restaurant is asked in a question, “how about the restaurant B.J. in lake tahoe”, the context-aware neural conversation model may detect that this question is asked in summer season and may recommend a better result other than B.J. when noticing that “lake tahoe” is not close to current context.

Then the step S408 may be convereted to find a response sentence or an answer Y={y₁, y₂, . . . , yₙ} to a given an input sentence X={x₁, x₂, . . . , xₙ}, by taking the context EC={ec₁, ec₂, . . . , ecₘ} into consideration, where x represents a word in the question, and y represents a word in the response. The problem of finding the response sentence Y may be converted to predict y by maximizing the probability P (yₜ|yₜ₋₁, . . . , y₁, ec). Neural network may be adopted to learn the representation of sentences without applying handcraft rules.

A typical neural conversational model each time may provide each sentence with an input gate, a memory gate, and an output gate, which are respectively denoted as iₜ, fₜ, and oₜ. xₜ denotes the vector for an individual text unit at time step t, hₜ denotes the vector computed by the LSTM model at time step t by combining xₜ and hₜ₋₁, cₜ denotes the cell state vector at time step t, and θ denotes the sigmoid function. Then, the vector representation hₜ for each time step t is given by:

$$\begin{matrix}〚 \begin{matrix}{i}_{t} \\ {f}_{t} \\ {o}_{t} \\ {l}_{t}\end{matrix} 〛 = 〚 \begin{matrix}θ \\ θ \\ θ \\ tanh\end{matrix} 〛 W * 〚 \begin{matrix}{h}_{t - 1} \\ {x}_{t}^{s}\end{matrix} 〛 & ( 1 ) \\ {c}_{t} = {f}_{t} {c}_{t - 1} + {i}_{t} {l}_{t} & ( 2 ) \\ {h}_{t}^{s} = {o}_{t} * tanh ( {c}_{t} ) & ( 3 )\end{matrix}$$

where

$$W = 〚 \begin{matrix}{W}_{i} \\ {W}_{t} \\ {W}_{o} \\ {W}_{l}\end{matrix} 〛 ,$$

where W denotes learned and trained factors, and Wᵢ, W_{f}, Wₒ, Wₗ∈R^{K*2K}.

Different from the SEQ2SEQ generation task, each input X may be paired with a sequence of predicted outputs: Y={y₁, y₂, . . . , yₙ}. The distribution over outputs and sequentially predicted tokens may be expressed by a softmax function:

$$p ( Y \vert X ) = {\prod }_{t = 1}^{{n}_{y}} p ( {y}_{t} \vert {x}_{1} , {x}_{2} , … , {x}_{t} , {y}_{1} , … , {y}_{t - 1} ) = {\prod }_{t = 1}^{{n}_{y}} \frac{exp ( f ( {h}_{t - 1} , {e}_{yt} ) )}{{\sum }_{{y}^{′}} exp ( f ( {h}_{t - 1} , {e}_{{y}^{′}} ) )} \qquad ( 4 )$$

where f (hₜ₋₁, e_{yt}) denotes an activation function between hₜ₋₁ and e_{yt} . Each sentence may be terminated with a special end-of-sentence symbol EOS. Thus, during decoding, the decoding algorithm may be terminated when an EOS token is predicted. At each time step, either a greedy approach or beam search may be adopted for word prediction.

After the answer to the question is generated, the answer is validated by an evidence validation model (S410). Although the answers are generated, the user may not accept the answers. Thus, a confidence score for quality control may be provided. In one embodiment, the confidence score may be calculated in normalized Kullback-Leibler distance (between 0 and 1) between the question and the answer. The calculation of Kullback-Leibler distance is well known by those skilled in the art, thus, is not explained here.

For example, a predetermined confidence score may be provided as a standard, and whether the answer is valid or not is determined based on the calculated confidence score of the answer (S411). If the calculated confidence score is larger than the predetermined confidence score, the corresponding answer may be considered as valid and the valid answer is delivered to the user (S412). If the calculated confidence score is smaller than the predetermined confidence score, the corresponding answer may be considered as invalid, and steps S408 and S410 and S411 may be repeated until the answer is determined as valid. In addition, the validated answers may also be used for training for the future questions.

The disclosed method and context-aware chatbot system may respond to the user or answer questions by taking the contextual information into consideration. To realize a more accurate representation of question, answer and context, the contextual information may be input into the context-aware neural conversation model. That is, the contextual information may be input into the chat robot at a system level. The context-aware neural conversation model may learn the contextual information and question answer pairs together. With the context-aware neural conversation model, the question answer pairs may be trained without handcrafted rules, and the contextual information may be decomposed into a plurality of high dimension vectors, such as people, and, organization, object, agent, occurrence, purpose, time, place, form of expression, concept/abstraction, and relationship, etc.

By analyzing the context in the questions, the user's question may be paired with a better answer. That is, the chatbot may provide more relevant responses to the users, and the users may find services and products they need in different contexts, significantly improving the user experience. The disclosed method and context-aware chatbot system may be applied to various interesting applications without handcrafted rules.

In addition, the disclosed method and context-aware chatbot system may provide a general learning frame for methods and systems which have to take contextual information into consideration. The learned word embedded presentation of context may be used for other tasks in future. The high dimension vectors representing the contextual information may also be used for personalization in recommender system in future.

Those of skill would further appreciate that the various illustrative modules and method steps disclosed in the embodiments may be implemented as electronic hardware, computer software, or combinations of both. To clearly illustrate this interchangeability of hardware and software, various illustrative units and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The description of the disclosed embodiments is provided to illustrate the present invention to those skilled in the art. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A context-aware chatbot method, comprising:
receiving a user's voice;
converting the user's voice to a question to be answered;
determining a question type of the question to be answered;
generating at least one answer to the question based on a context-aware neural conversation model;
validating the answer generated by the context-aware neural conversation model; and
delivering the answer validated to the user,
wherein the context-aware neural conversation model takes contextual information of the question into consideration, and decomposes the contextual information of the question into a plurality of high dimension vectors.

2. The context-aware chatbot method according to claim 1, wherein determining a question type of the question to be answered further including:
identifying a Lexical Answer Type (LAT) of the question to be answered.

3. The context-aware chatbot method according to claim 1, wherein generating at least one answer to the question based on a context-aware neural conversation model further including:
provided an input sentence X={x₁, x₂, . . . , xₙ}, finding a response sentence Y={y₁, y₂, . . . , yₙ} by taking a context EC={ec₁, ec₂, . . . , ec_{,}} into consideration, wherein x represents a word in the input sentence, y represents a word in the response sentence, the response sentence Y represents the answer, and the input sentence X represents the question to be answered.

4. The context-aware chatbot method according to claim 3, wherein provided an input sentence X={x₁, x₂, . . . , xₙ}, finding a response sentence Y={y₁, y₂, . . . , yₙ} by taking a context EC={ec₁, ec₂, . . . , ecₘ} into consideration further including:
predicting y by maximizing a probability P (yₜ|yₜ₋₁, . . . , y₁,ec).

5. The context-aware chatbot method according to claim 4, wherein predicting y by maximizing a probability P (yₜ|yₜ₋₁, . . . , y₁, ec) further including:
providing the input sentence with an input gate iₜ, a memory gate fₜ, and an output gate oₜ, by the context-aware neural conversation model; and
calculating a vector representation hₜ for each time step t by:
$$\begin{matrix}〚 \begin{matrix}{i}_{t} \\ {f}_{t} \\ {o}_{t} \\ {l}_{t}\end{matrix} 〛 = 〚 \begin{matrix}θ \\ θ \\ θ \\ tanh\end{matrix} 〛 W * 〚 \begin{matrix}{h}_{t - 1} \\ {x}_{t}^{s}\end{matrix} 〛 \\ {c}_{t} = {f}_{t} {c}_{t - 1} + {i}_{t} {l}_{t} \\ {h}_{t}^{s} = {o}_{t} * tanh ( {c}_{t} ) ,\end{matrix}$$
where
$$W = 〚 \begin{matrix}{W}_{i} \\ {W}_{t} \\ {W}_{o} \\ {W}_{l}\end{matrix} 〛 ,$$
where Wᵢ, W_{f}, Wₒ, Wₗ∈R^{K*2K}, W denotes learned and trained factors, xₜ denotes a vector representation for an individual word at time step t, hₜ denotes a vector representation computed by Long Short Term Memory (LSTM) model at the time step t by combining xₜ and hₜ₋₁, cₜ denotes a cell state vector representation at time step t, and θ denotes a sigmoid function.

6. The context-aware chatbot method according to claim 5, further including:
calculating a distribution over outputs and sequentially predicted tokens based on a softmax function:
$$p ( Y \vert X ) = {\prod }_{t = 1}^{{n}_{y}} p ( {y}_{t} \vert {x}_{1} , {x}_{2} , … , {x}_{t} , {y}_{1} , … , {y}_{t - 1} ) = {\prod }_{t = 1}^{{n}_{y}} \frac{exp ( f ( {h}_{t - 1} , {e}_{yt} ) )}{{\sum }_{{y}^{′}} exp ( f ( {h}_{t - 1} , {e}_{{y}^{′}} ) )} ,$$
where f (hₜ₋₁, e_{yt}) denotes an activation function between hₜ₋₁ and e_{yt} .

7. The context-aware chatbot method according to claim 6, wherein:
terminating a decoding of the input sentence when an EOS token is predicted.

8. The context-aware chatbot method according to claim 1, wherein validating the answer generated by the context-aware neural conversation model further including:
calculating a confidence score for the answer generated by the context-aware neural conversation model, wherein the confidence score is a normalized Kullback-Leibler distance between the question and the answer.

9. A non-transitory computer-readable medium having computer program for, when being executed by a processor, performing a context-aware chatbot method, the method comprising:
receiving a user's voice;
converting the user's voice to a question to be answered;
determining a question type of the question to be answered;
generating at least one answer to the question based on a context-aware neural conversation model;
validating the answer generated by the context-aware neural conversation model; and
delivering the answer validated to the user,
wherein the context-aware neural conversation model takes contextual information of the question into consideration, and decomposes the contextual information of the question into a plurality of high dimension vectors.

10. The non-transitory computer-readable medium according to claim 9, wherein determining a question type of the question to be answered further including:
identifying a Lexical Answer Type (LAT) of the question to be answered.

11. The non-transitory computer-readable medium according to claim 9, wherein generating at least one answer to the question based on a context-aware neural conversation model further including:
given an input sentence X={x₁, x₂, . . . , xₙ}, finding a response sentence Y={y₁, y₂, . . . , yₙ} by taking a context EC={ec₁, ec₂, . . . , ecₘ} into consideration, where x represents a word in the input sentence, y represents a word in the response sentence, the response sentence Y represents the answer, and the input sentence X represents the question to be answered.

12. The non-transitory computer-readable medium according to claim 11, wherein given an input sentence X={x₁, x₂, . . . , xₙ}, finding a response sentence Y={y₁, y₂, . . . , yₙ} by taking a context EC={ec₁, ec₂, . . . , ecₘ} into consideration further including:
predicting y by maximizing a probability P (yₜ|yₜ₋₁, . . . , y₁, ec).

13. The non-transitory computer-readable medium according to claim 12, wherein predicting y by maximizing a probability P (yₜ|yₜ₋₁, . . . , y₁, ec) further including:
providing the input sentence with an input gate iₜ, a memory gate fₜ, and an output gate oₜ, by the context-aware neural conversation model;
calculating a vector representation hₜ for each time step t by:
$$\begin{matrix}〚 \begin{matrix}{i}_{t} \\ {f}_{t} \\ {o}_{t} \\ {l}_{t}\end{matrix} 〛 = 〚 \begin{matrix}θ \\ θ \\ θ \\ tanh\end{matrix} 〛 W * 〚 \begin{matrix}{h}_{t - 1} \\ {x}_{t}^{s}\end{matrix} 〛 \\ {c}_{t} = {f}_{t} {c}_{t - 1} + {i}_{t} {l}_{t} \\ {h}_{t}^{s} = {o}_{t} * tanh ( {c}_{t} ) ,\end{matrix}$$
where
$$W = 〚 \begin{matrix}{W}_{i} \\ {W}_{t} \\ {W}_{o} \\ {W}_{l}\end{matrix} 〛 ,$$
where Wᵢ, W_{f}, Wₒ, Wₗ∈R^{K*2K}, W denotes learned and trained factors, xₜ denotes a vector representation for an individual word at time step t, hₜ denotes a vector representation computed by Long Short Term Memory (LSTM) model at the time step t by combining xₜ and hₜ₋₁, cₜ denotes a cell state vector representation at time step t, and θ denotes a sigmoid function, and
calculating a distribution over outputs and sequentially predicted tokens based on a softmax function
$$p ( Y \vert X ) = {\prod }_{t = 1}^{{n}_{y}} p ( {y}_{t} \vert {x}_{1} , {x}_{2} , … , {x}_{t} , {y}_{1} , … , {y}_{t - 1} ) = {\prod }_{t = 1}^{{n}_{y}} \frac{exp ( f ( {h}_{t - 1} , {e}_{yt} ) )}{{\sum }_{{y}^{′}} exp ( f ( {h}_{t - 1} , {e}_{{y}^{′}} ) )} ,$$
where f (hₜ₋₁, e_{yt}) denotes an activation function between hₜ₋₁ and e_{yt}.

14. The non-transitory computer-readable medium according to claim 9, wherein validating the answer generated by the context-aware neural conversation model further including:
calculating a confidence score for the answer generated by the context-aware neural conversation model, wherein the confidence score is a normalized Kullback-Leibler distance between the question and the answer.

15. A context-aware chatbot system, comprising:
a question acquisition module configured to receive a user's voice and convert the user's voice to a question to be answered;
a question determination module configured to determine a question type of the question to be answered;
a context-aware neural conversation module configured to generate at least one answer to the question by taking contextual information of the question into consideration and decomposing the contextual information of the question into a plurality of high dimension vectors;
an evidence validation module configured to validate the answer generated by the context-aware neural conversation model; and
an answer delivery module configured to deliver the answer validated to the user.

16. The context-aware chatbot system according to claim 15, wherein the question determination module is configured to:
identify a Lexical Answer Type (LAT) of the question to be answered.

17. The context-aware chatbot system according to claim 15, wherein the context-aware neural conversation module is configured to:
given an input sentence X={x₁, x₂, . . . , xₙ}, find a response sentence Y={y₁, y₂, . . . , yₙ} by taking a context EC={ec₁, ec₂, . . . , ecₘ} into consideration, where x represents a word in the input sentence, y represents a word in the response sentence, the response sentence Y represents the answer, and the input sentence X represents the question to be answered.

18. The context-aware chatbot system according to claim 17, wherein the context-aware neural conversation module is configured to:
predict y by maximizing a probability P (yₜ,|yₜ₋₁, . . . , y₁, ec).

19. The context-aware chatbot system according to claim 18, wherein the context-aware neural conversation module is configured to:
provide the input sentence with an input gate iₜ, a memory gate fₜ, and an output gate oₜ, by the context-aware neural conversation model;
calculate a vector representation hₜ for each time step t by:
$$\begin{matrix}〚 \begin{matrix}{i}_{t} \\ {f}_{t} \\ {o}_{t} \\ {l}_{t}\end{matrix} 〛 = 〚 \begin{matrix}θ \\ θ \\ θ \\ tanh\end{matrix} 〛 W * 〚 \begin{matrix}{h}_{t - 1} \\ {x}_{t}^{s}\end{matrix} 〛 \\ {c}_{t} = {f}_{t} {c}_{t - 1} + {i}_{t} {l}_{t} \\ {h}_{t}^{s} = {o}_{t} * tanh ( {c}_{t} ) ,\end{matrix}$$
where
$$W = 〚 \begin{matrix}{W}_{i} \\ {W}_{t} \\ {W}_{o} \\ {W}_{l}\end{matrix} 〛 ,$$
where Wᵢ, W_{f}, Wₒ, Wₗ∈R^{K*2K},W denotes learned and trained factors, xₜ denotes a vector representation for an individual word at time step t, hₜ denotes a vector representation computed by Long Short Term Memory (LSTM) model at the time step t by combining xₜ and hₜ₋₁, cₜ denotes a cell state vector representation at time step t, and θ denotes a sigmoid function, and
calculate a distribution over outputs and sequentially predicted tokens based on a softmax function
$$p ( Y \vert X ) = {\prod }_{t = 1}^{{n}_{y}} p ( {y}_{t} \vert {x}_{1} , {x}_{2} , … , {x}_{t} , {y}_{1} , … , {y}_{t - 1} ) = {\prod }_{t = 1}^{{n}_{y}} \frac{exp ( f ( {h}_{t - 1} , {e}_{yt} ) )}{{\sum }_{{y}^{′}} exp ( f ( {h}_{t - 1} , {e}_{{y}^{′}} ) )} ,$$
where f (hₜ₋₁, e_{yt}) denotes an activation function between hₜ₋₁ and e_{yt}.

20. The context-aware chatbot system according to claim 15, wherein the evidence validation module is further configured to:
calculate a confidence score for the answer generated by the context-aware neural conversation model, wherein the confidence score is a normalized Kullback-Leibler distance between the question and the answer.
